(19) United States
(12) Patent Application Publication
(10) Pub. No.: US 2023/0402782 A1
(43) Pub. Date: Dec. 14, 2023

(54) ELECTRICAL CONNECTOR HAVING LIVING HINGE AND INDEPENDENT SECONDARY TERMINAL LOCK (ISL), AND METHOD FOR OPERATING THEREOF

(71) Applicant: J.S.T. CORPORATION, Farmington Hills, MI (US)

(72) Inventors: Cecil BROWN, Southfield, MI (US); Franklin A. HOLUB, West Bloomfield, MI (US); Ping CHEN, Novi, MI (US)

(73) Assignee: J.S.T. CORPORATION, Farmington Hills, MI (US)

(21) Appl. No.: 17/869,699

(22) Filed: Jul. 20, 2022

Related U.S. Application Data
(60) Provisional application No. 63/351,233, filed on Jun. 10, 2022.

(51) Int. Cl. H01R 13/422; H01R 43/20

(52) U.S. Cl. CPC H01R 13/422; H01R 43/20

(57) ABSTRACT

An electrical connector having a housing for receiving therein at least one terminal; a hinged cover, operably coupled to the housing, for covering the terminal received by the housing; at least a hinge member operably coupled to the housing and the hinged cover; and an independent secondary terminal lock (ISL) within the hinged cover for locking the terminal within the housing when the hinged cover is at a closed position. The ISL blocks the terminal from being removed or dislodged from the housing. The housing and the hinged cover have a locking mechanism that retains and secures the hinged cover onto the housing, and thereby locks the terminal within the housing. Alternatively, the housing and the hinged cover have another locking mechanism that includes a substantially flexible member having an elongated slot and extending from a side portion of the housing for accommodating therein at least an elongated retention member extending from at least a side of the hinged cover.

### CROSS-REFERENCE TO RELATED APPLICATION

This patent application claims priority to U.S. Provisional Patent Application No. 63/351,233 filed Jun. 10, 2022, which is hereby incorporated herein by reference in its entirety.

### SUMMARY OF THE INVENTION

An electrical connector of this invention has at least a living hinge and at least an independent secondary terminal lock (ISL), the electrical connector being preferably a single piece with a housing and the ISL suspended on (or located beneath) a hinged cover off of the living hinge. The ISL suspended beneath the hinged cover is suspended via the living hinge prior to the insertion of a terminal into the housing in such a position for allowing the housing to be made with a mold that does not require mold “slides” or separate components to establish ISL function.

After the insertion of the terminal into the housing, the ISL, suspended beneath the hinged cover, is swung into a “locked” position and “trapped” into a position via a combination of slots, protrusions, and holes so as to maintain the ISL in position even if the living hinge were to fail. The housing of the electrical connector of this invention may include at least one terminal, along with at least one corresponding ISL suspended beneath the hinged cover off of the living hinge. The terminal or a corresponding connector terminal cavity within the housing may, alternatively, have a structural arrangement, element, or feature for locking the terminal into a cavity (e.g., in the form of at least a cavity lock finger and terminal lance). Also, although the ISL of the electrical connector of this invention provides a secondary lock or retention means for the terminal, the ISL of the electrical connector of this invention may, alternatively, be the sole means for locking or retaining the terminal.

### BRIEF DESCRIPTION OF THE DRAWINGS

FIG. 1 is a perspective front view of the electrical connector of this invention having living hinges and an associated hinged push pad or hinged cover.

FIG. 2 is a perspective rear or back view of the electrical connector illustrating the positioning of the terminals during the insertion thereof within the housing and prior to final locks thereof and the closing of the associated hinged pushed pad or hinged cover.

FIG. 3 is a perspective rear view of the electrical connector illustrating the positioning of the terminals after the insertion thereof within the housing, but prior to the final locking thereof within the housing and prior to the closing of the associated hinged pushed pad or hinged cover.

FIG. 4 is a perspective rear view of the electrical connector illustrating the final lock position of the terminals after the closing of the associated hinged pushed pad or hinged cover.

FIG. 5A is a perspective rear view of the electrical connector illustrating the positioning of the terminals after the insertion thereof within the housing and the final locking thereof within the housing, but prior to the closing of the associated hinged pushed pad or hinged cover, FIG. 5A showing a retention member for the associated hinged pushed pad or hinged cover, and further having a squared sectional designated portion that is shown in more detail in FIG. 5B.

FIG. 5B is an enlargement of the squared sectional designated portion in FIG. 5A illustrating, in more detail, terminal blockers (or the above-mentioned independent secondary terminal locks (ISL), which are preferably suspended beneath the associated hinged pushed pad or hinged cover.

FIG. 6A is a perspective rear view of the electrical connector illustrating the positioning of the terminals after the insertion thereof within the housing, but prior to the final locking thereof within the housing and prior to the closing of the associated hinged pushed pad or hinged cover, FIG. 6A further having a squared sectional designated portion that is shown in more detail in FIG. 6B.

FIG. 6B is an enlargement of the squared sectional designated portion in FIG. 6A illustrating, in more detail, a hinged cover retention slot for ensuring that the associated hinged pushed pad or hinged cover is retained on the housing.

### DETAILED DESCRIPTION OF THE PREFERRED EMBODIMENTS

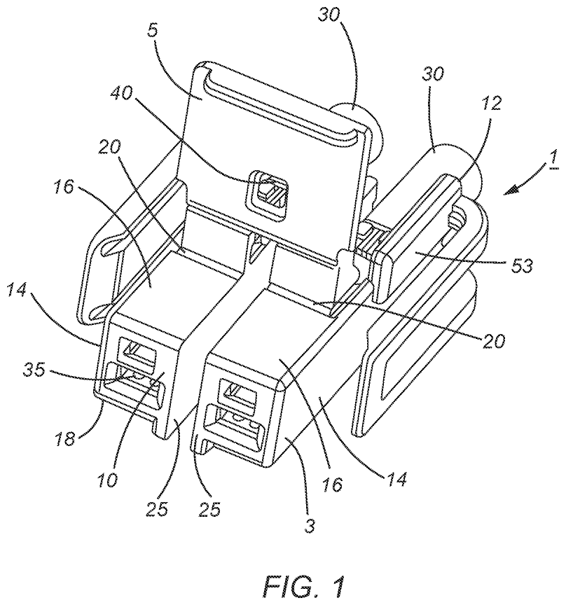

FIG. 1 is a perspective front view of the electrical connector of this invention, generally referred to as reference number 1. The electrical connector 1 has a housing 3 and a hinged cover (or a hinged push pad) 5. The housing 3 has a front portion 10, rear portion 12, side portions 14, upper portion 16, and bottom portion 18. The hinged push pad or hinged cover 5 is, as illustrated in FIG. 1, located on the upper portion 16 of the housing 3. Also shown in FIG. 1 is the front portion 10 of the housing 3 composed of at least two substantially box-like members 25, each box-like member 25 accommodating therein a terminal 30 that enters the housing 3 through the rear portion 12 thereof.

Also illustrated in FIG. 1 is a living hinge (or integral hinge) 20 that connects hinged cover 5 to the upper portion 16 of the housing 3, FIG. 1 showing two living hinges (or integral hinges) 20. More particularly, the upper portion 16 of each of the box-like members 25, which make up the front portion 10 of the housing 3, is respectively operably coupled to the hinged cover 5 by one of the living hinges 20. Each of the living hinges 20 is preferably a relatively thin flexible hinge substantially made from the same material as the hinged cover 5 and the housing 3 (or the box-like member 25) to which the living hinges 20 connect. It is preferable that each of the living hinges 20 is thinned out or cut for allowing the hinged cover 5 and the housing 3 (or the corresponding box-like member 25) to bend along the line along which the living hinge 20 extends. The minimal friction and the relatively little wear of the living hinge 20 makes it very useful when used multiple times in the electrical connector 1 of this invention.

As also shown in FIG. 1, the front portion 10 of the housing 3 includes input ports 35, each input port 35 capable of receiving therein an external terminal (not shown) for connecting with the corresponding terminal 30 that respectively enters one of the corresponding box-like member 25 of the housing 3 through the rear portion 12 thereof.

Further illustrated in FIG. 1 is an aperture 40 passing through the hinged cover 5, the function of which will be discussed in more detail below. Also shown in FIG. 1 is an elongated retention member 53 attached to each side portion 14 of the housing 3, the function of which will also be discussed in more detail below. The elongated retention member 53, attached to each side portion 14 of the housing 3, is preferably flexible.

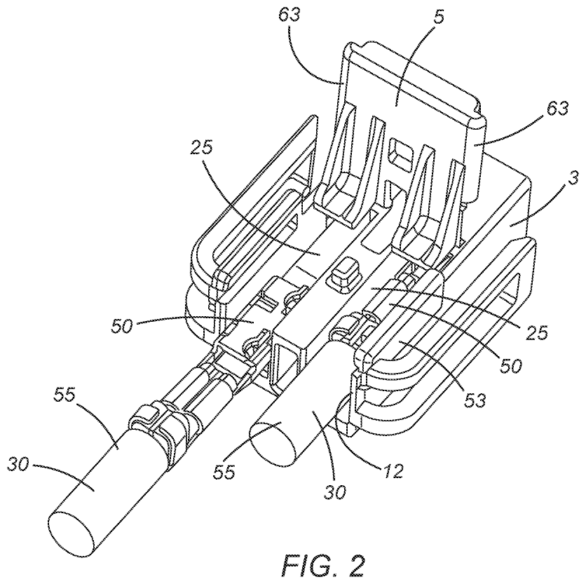

FIG. 2 shows the electrical connector 1 illustrating the rear portion 12 thereof and the positioning of the terminals 30 during the insertions thereof within the housing 3, and prior to final locks thereof and the closing of the hinged cover 5. The housing 3, at the rear portion 12 thereof, is composed of the box-like members 25, each box-like member 25 of the housing 3 accommodating therein the terminal 30 that enters the housing 3 through the rear portion 12 thereof. The box-like members 25 of the rear portion 12 of the housing have the top portions thereof open and to be converted by the hinged cover 3. Prior to the insertion of the terminal 30 (see left terminal 30 in FIG. 2) inside the box-like member 25, the conductive portion 50 is first inserted within the box-like portion 25. Upon completion of the insertion of the terminal 30 (see right terminal 30 in FIG. 2), the box-like member 25 of the housing 3 therein accommodates the conductive portion 50 of the terminal 30 and a portion of the insulated portion 55 of the terminal 30.

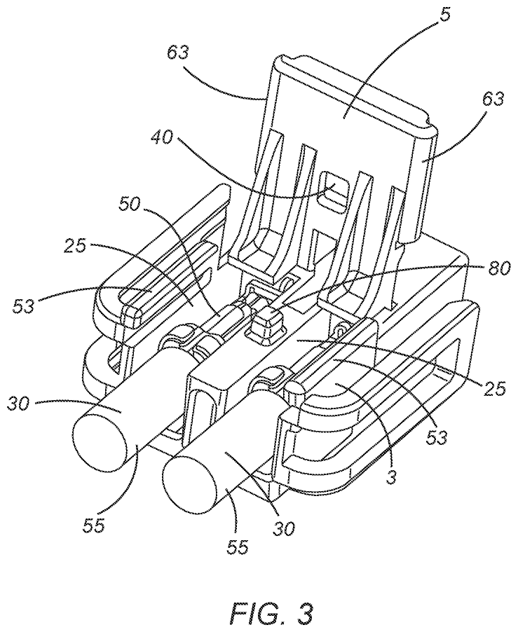

FIG. 3 shows a perspective view of the electrical connector 1 from the direction of its rear portion 12 and shows the positioning of the terminals 30 after the insertion thereof within the housing 3, but prior to the final locking thereof within the housing 3 and prior to the closing of the hinged cover 5. In FIG. 3, the terminals 30 are inserted into the box-like members 25, respectively, of the housing 3. More particularly, the conductive portions 50 and parts of the insulated portions 55 of the terminals 30 have been respectively inserted into the box-like members 25 of the housing 3. The terminals 30 are respectively inserted into the box-like members 25 of the housing 3 until the ends of the conductive portions 60 of the terminals 30 reach the input ports 35 of the front portion 10 of the housing 3, as discussed above with respect to FIG. 1. With the terminals 30 being fully inserted into the box-like members 25 of the housing 3, and having reached the input ports 35 in the front portion 10 of the housing 3, the conductive portions 50 of the terminals 30 are capable of respectively receiving or connecting with external terminals (now shown), At this time, as shown in FIG. 3, the hinged cover 5 remains open, and the terminals 30 remain unlocked.

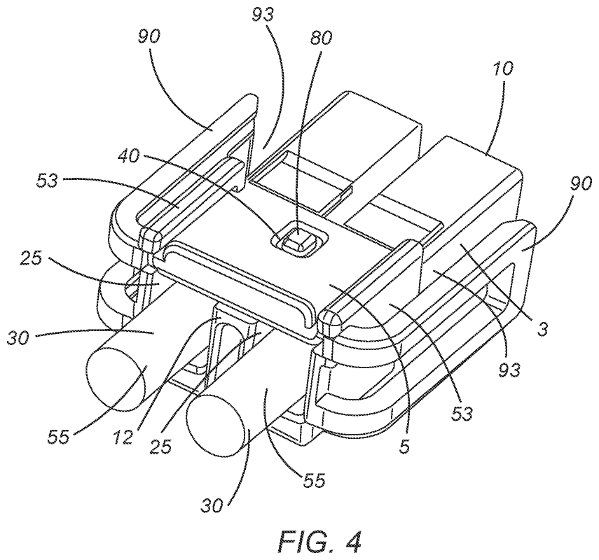

Further illustrated in FIG. 3 is the aperture 40 passing through the hinged cover 5 and a bump portion 80 extending from the upper portion 16 of the housing 3. The aperture 40 of the hinged cover 5 accommodates therein the bump portion 80 of the housing 3 so that when the hinged cover 5 closes (that is, closes onto the housing 3), the hinged cover 5 is retained and remains secure onto the housing 3 (see FIG. 4). Although the aperture 40 of the hinged cover 5 is substantially centrally located through the hinged cover 5 and the bump portion 80 is substantially centrally located on the upper portion 16 of the housing 3, as shown in FIG. 3, the above-described respective locations of the aperture 40 and the bump portion 80 are not limited thereto. That is, the locations of the aperture 40 and the bump portion 80 may be located anywhere through the hinged cover 5 and the upper portion 16 of the housing 3, respectively, as long as they engage with each other, in the manner described above, to provide, when the hinged cover 5 is at a closed position, the requisite retention of the hinged cover 5 onto the housing 3 and to secure the hinged cover 5 onto the housing 3.

FIG. 4 shows the final locked positions of the terminals 30 within the housing 3 after the closing of the hinged cover 5 onto the housing 3. As shown in FIG. 4, the terminals 30 have been fully inserted into the box-like members 25 that make up the rear portion 12 (and the front portion 10) of the housing 3, and the bump portion 80 extending from the upper portion 16 of the housing 3 has been fully received or accommodated within the aperture 40 passing through the hinged cover 5, thereby securing the retention of the hinged cover 5 onto the housing 3.

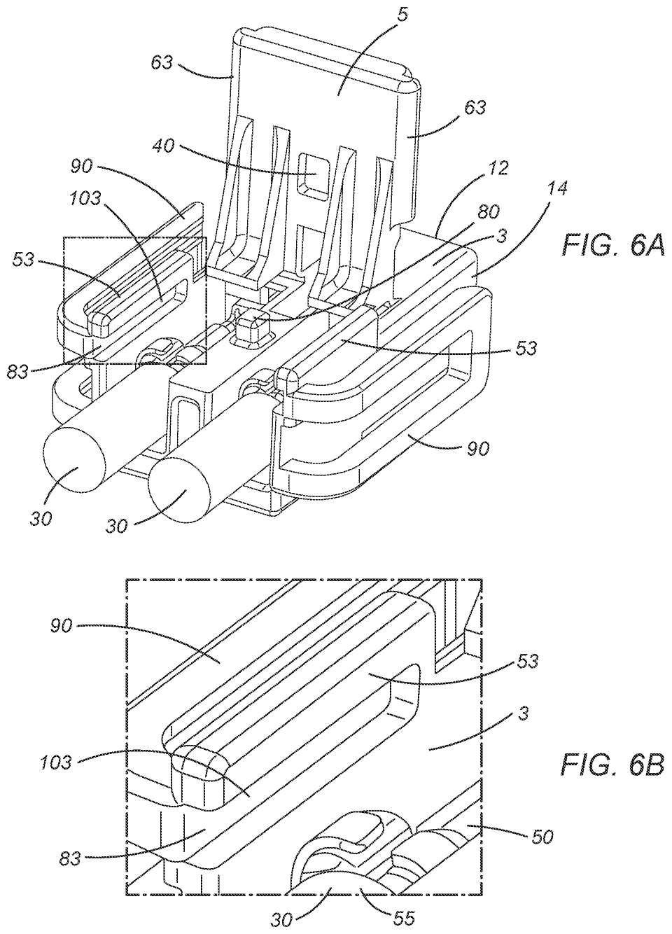

When the hinged cover 5 is in the closed position, as shown in FIG. 4, elongated members 63 (see FIGS. 2 and 3) that respectively extend along the sides of the hinged cover 5 are retained and secured by and within the flexible elongated retention members 53, each flexible elongated retention member 53 being attached to each side portion 14 of the housing 3, as more fully discussed in detail with respect to FIGS. 6A and 6B. Although also shown in previous figures, the electrical connector 1 of this invention, as illustrated in FIG. 4, is fully locked and the terminals 30 within the housing 3 are retained and secured by the bump portion 80 extending from the upper portion 16 of the housing 3 being accommodated within the aperture 40 passing through the hinged cover 5, and further retained and secured by the elongated members 63, which respectively extend along the sides of the hinged cover 5, being retained and secured by and within the flexible elongated retention members 53 attached to the side portions 14 of the housing 3.

With the hinged cover 5 being fully retained and secured within the housing 3, as illustrated in FIG. 4, dual locking latches 90 respectively further extend from the side portions 14 of the housing 3. The dual locking latches 90 allow for the easy and convenient attachment of the fully closed and locked electrical connector 1 of this invention to an external component or device (not shown). As further illustrated in FIG. 4, each of the dual locking latches 90 is preferably U-shaped, as shown, although the shape thereof is not limited thereto. Also, each of the dual locking latches 90 is preferably flexible and provides for an open access 93 between the locking latches 90 and the corresponding side portion 14 of the housing 3 for conveniently receiving therein, when in use, a portion of the external component or device (not shown) to which the electrical connector 1 latches or mounts onto.

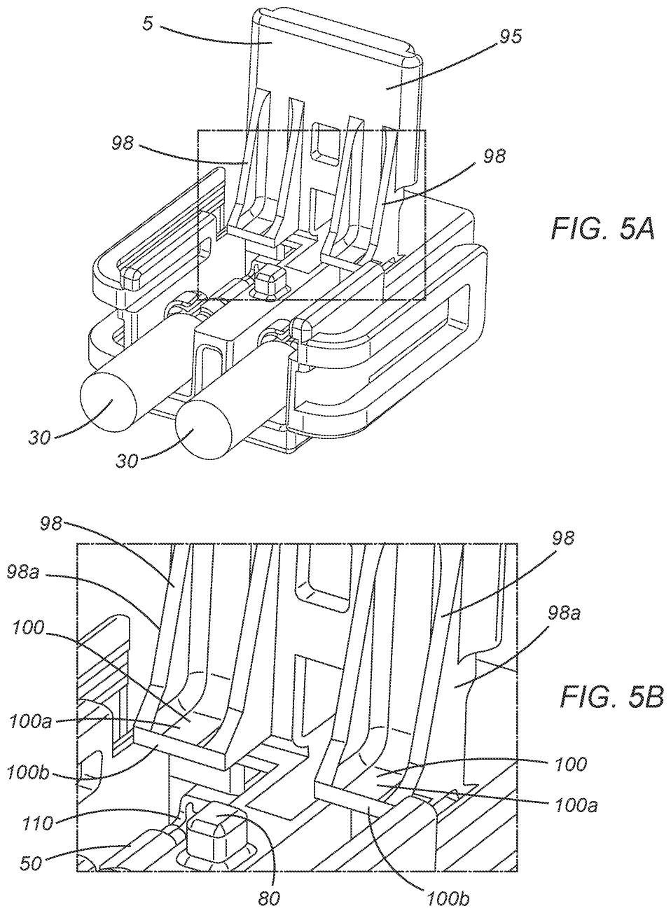

FIG. 5A shows the positioning of the terminals 30 within the housing 3 after the insertion thereof within the housing 3 and the final locking thereof within the housing 3, but prior to the closing of the hinged cover 5. The hinged cover 5 includes, at an inner surface 95 thereof, elongated terminal support members 98, which, upon closure of the hinged cover 5 onto the housing 3, respectively support the terminals 30 so as tp respectively secure the terminals 30 within the housing 3. As seen in the enlarged portion (see FIG. 5B) of FIG. 5A, each of the elongated terminal support members 98 includes sides 98a that extend in the same direction as the direction along which the terminals 30 extend when the hinged cover 5 is at a closed position. At the respective ends of the sides 98a, nearest the upper portion 16 of the housing 3, are terminal blockers (or independent secondary terminal locks (ISLs) 100. The terminal blockers 100, as shown in FIG. 5B, is comprised of at least a first inner surface 100a and a second inner surface 100b, the first inner surface 100a and the second inner surface 100b being substantially perpendicular from each other.

When in use and upon the closure of the hinged cover 5 onto the housing 3, the first inner surface 100a of the terminal blocker 100 blocks a portion of the corresponding or adjoining conductive portion 50 of the terminal 30, thereby preventing the terminal 30 from being removed or detached from the box-like member 25 of the housing 3. For example, the conductive portion 50 of the terminal 30 may have a space 110 for accommodating therein the terminal blocker 100 when the hinged cover 5 is at the closed position. Also when the hinged cover 5 is at the closed position, the second inner surface 100b of the terminal blocker 100 may, alternatively, impinged or abut against the corresponding or adjoining conductive portion 50 of the terminal 30 for additional retention in ensuring that the terminals 30 are not removed or detached from the respective box-like member 25 of the housing 3. It is for the above reasons that the terminal blockers 100 respectively act as independent secondary terminal locks (ISLs) for the terminals 30 locked within their respective box-like members 25 of the housing 3.

FIG. 6A shows the positioning of the terminals 30 after the insertions thereof within the box-like members 25 of the housing 3, but prior to the final locking thereof within the box-like members 25 of the housing 3 and prior to the closing of the hinged cover 5. As can also be seen in FIG. 6A, the elongated members 63 respectively extend along the sides of the hinged cover 5. The elongated members 63 that extend along the sides of the hinged cover 5 are respectively accommodated within the respective retention slots 103 at inner surfaces 83 of the flexible elongated retention members 53 that respectively extend along the side portions 14 of the housing 3. It is preferred that each of the elongated members 63, which extends along the respective side of the hinged cover 5, is substantially rounded or chamfered to allow easy insertion or accommodating thereof into the corresponding retention slot 103. Consequently, when the hinged cover 5 closes onto the housing 3, the elongated members 63 (preferably rounded or chamfered) respectively snap into the adjacent retention slots 103 at the inner surfaces 83 of the flexible elongated retention members 53, which extend from the side portions 14 of the housing 3.

FIG. 6B illustrates the enlargement of the squared sectional designated portion in FIG. 6A, which more particularly shows the retention slot 103 that extends along the inner surface 83 of the flexible elongated retention member 53 attached to the side portion 14 of the housing 3. As discussed above, the elongated members 63 that extend along the respective sides of the hinged cover 5 are accommodated (or preferably snap into) the respective retention slots 103 along the inners surfaces 83 of the respective flexible elongated retention members 53, which result in the hinged cover 5 being retained onto the housing 3 when the hinged cover 5 is at a closed position.

Summarily, each of the elongated retention members 53 that respectively extend from the side portion 14 of the housing 3 is preferably flexible, while each of the elongated members 63 that extend along a side of the hinged cover 5 is substantially rounded or chamfered, to achieve a snug or substantially snapping closure of the hinged cover 5 onto the housing 3 when the elongated members 63 extending along the sides of the hinged cover 5 are respectively accommodated within the retention slots 103 along the respective inner surfaces 83 of the flexible elongated retention members 53 that extend from the side portions 14 of the housing 3.

The present invention is not limited to the above-described embodiments; and various modifications in design, structural arrangement or the like may be used without departing from the scope or equivalents of the present invention.

We claim:

1. An electrical connector, comprising:
a housing for receiving therein at least one terminal;
a hinged cover, operably coupled to said housing, for covering said terminal received by said housing;
at least a hinged member operably coupled to said housing and said hinged cover; and
an independent secondary terminal lock (ISL) within said hinged cover for locking said terminal within said housing when said hinged cover is at a closed position.

2. The electrical connector according to claim 1, wherein said housing has a front portion, a rear portion, an upper portion, a bottom portion, and side portions, wherein said hinged cover is operably coupled to said upper portion of said housing.

3. The electrical connector according to claim 2,
wherein said rear portion of said housing includes at least one recess for receiving therein said terminal, and
wherein said front portion of said housing includes at least one input port for receiving therein an external terminal for connecting with said terminal received by said housing through said rear portion thereof.

4. The electrical connector according to 1, wherein said hinged cover has a portion that acts as a hinged cover retention with said housing when said hinged cover is at a closed position.

5. The electrical connector according to claim 4, wherein said portion that acts as a hinged cover retention with said housing comprises:
an aperture passing through said hinged cover, and
a bump portion extending from said upper portion of said housing, said aperture of said hinged cover receiving therein said bump portion of said housing when said hinged cover is at a closed position thereby retaining said hinged cover onto said housing.

6. The electrical connector according to claim 5, wherein said hinged cover comprises at least an elongated retention member extending from a side thereof for further securing said hinged cover onto said housing when said hinged cover is at a closed position.

7. The electrical connector according to claim 6, further comprising at least a substantially flexible member extending from at least one of said side portion of said housing and having an elongated retention slot for receiving therein said elongated retention member of said hinged cover for securing said hinged cover onto said housing when said hinged cover is at a closed position.

8. The electrical connector according to claim 1, wherein said hinged cover locks said terminal within said housing when said hinged cover is at a closed position.

9. The electrical connector according to claim 1, wherein said hinged member is a living hinged or integral hinged integral to and made of the same material as said hinged cover and said upper portion of said housing.

10. A method for locking at least a terminal within a housing with at least an independent secondary terminal lock (ISL), comprising the steps of:
inserting said terminal within a recess of said housing;
closing a hinged cover onto said housing and over said terminal, said hinged cover having said ISL therein; and
blocking said terminal by said ISL when said hinged cover is at a closed position.

11. The method for locking said terminal within said housing with said ISL according to claim 10, further comprising the step of retaining or securing said hinged cover onto said housing when said hinged cover is at a closed position.

12. The method for locking said terminal within said housing with said ISL according to claim 11, wherein said step of retaining or securing said hinged cover onto said housing comprises a step of fitting a bump portion extending from an upper portion of said housing within a recess passing through said hinged cover when said hinged cover is at a closed position.

13. The method for locking said terminal within said housing with said ISL according to claim 12, wherein said step of retaining or securing said hinged cover onto said housing further comprises the step of fitting at least an elongated retention member extending from at least a side of said hinged cover into at least an elongated retention slot along a member extending from said side portion of said housing.

14. The method for locking said terminal within said housing with said ISL according to claim 13, wherein said step of retaining or securing said hinged cover onto said housing further comprises the step of flexibly fitting said elongated retention member extending from said side of said hinged cover into said elongated retention slot along said member extending from said side portion of said housing.

15. An electrical connector, comprising:
a housing for receiving therein at least one terminal;
a hinged cover, operably coupled to said housing, for covering said terminal received by said housing;
at least a hinged member operably coupled to said housing and said hinged cover; and
an independent secondary terminal lock (ISL) within said hinged cover for locking said terminal within said housing when said hinged cover is at a closed position, said ISL blocks said terminal from being removed or dislodged from said housing,
wherein said housing has a front portion, a rear portion, an upper portion, a bottom portion, and side portions, wherein said hinged cover is operably coupled to said upper portion of said housing,
wherein said rear portion of said housing includes at least one recess for receiving therein said terminal,
wherein said front portion of said housing includes at least one input port for receiving therein an external terminal for connecting with said terminal received by said housing through said rear portion thereof, and
wherein at least said housing, said hinge cover, sand hinged member, and said ISL constitute a contiguous single piece that makes up said electrical connector.

16. The electrical connector according to 15, wherein said hinged cover has a portion thereof that acts as a hinged cover retention with said housing when said hinged cover is at a closed position.

17. The electrical connector according to claim 16, wherein said portion of said hinged cover that acts as a hinged cover retention with said housing comprises:
an aperture passing through said hinged cover, and
a bump portion extending from said upper portion of said housing, said aperture of said hinged cover receiving therein said bump portion of said housing when said hinged cover is at a closed position thereby retaining or securing said hinged cover onto said housing.

18. The electrical connector according to claim 15, wherein said hinged cover comprises at least an elongated retention member extending from a side thereof for further retaining and securing said hinged cover onto said housing when said hinged cover is at a closed position.

19. The electrical connector according to claim 18, further comprising at least a substantially flexible member extending from at least one of said side portions of said housing and having an elongated retention slot for receiving therein said elongated retention member of said hinged cover for further retaining and securing said hinged cover onto said housing when said hinged cover is at a closed position.

20. The electrical connector according to claim 15, wherein said hinged cover locks said terminal within said housing when said hinged cover is at a closed position.
